(19) United States
(12) Patent Application Publication
(10) Pub. No.: US 2007/0044611 A1
(43) Pub. Date: Mar. 1, 2007

(54) Food slicer

(76) Inventors: Frank A. Bondarowicz, Glenview, IL (US); Scott J. Rote, New Lenox, IL (US); Scott M. Zeeb, Chicago, IL (US); Aaron B. Eiger, Chicago, IL (US); Philip Anthony, Chicago, IL (US); Todd L. Clem, Goshen, IN (US); Hardev S. Somal, LaPorte, IN (US); James Fournier, South Brnd, IN (US); Alan Varacins, Burlington, WI (US); James W. Robinson, Mundelein, IL (US)

Correspondence Address: Mark W. Croll;Illinois Tool Works Inc., 3600 West Lake Avenue, Glenview, IL, 60026, US

(21) Appl. No.: 11/348,566

(22) Filed: Feb. 7, 2006

Related U.S. Application Data
(60) Provisional application No. 60/711,708, filed on Aug. 26, 2005.

(51) Int. Cl. B26D 7/06

(52) U.S. Cl. 83/247; 83/717

(57) ABSTRACT

A food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade. The base portion includes a food product table slidably secured thereto and is movable across the cutting blade for holding product while it is being sliced by the cutting blade. An adjustable gage plate also is provided for determining the thickness of a food product to be sliced by the cutting blade. First and second top surfaces are formed by a distal end of the upstanding portion of the support member. The base portion and the upstanding portion are formed as a single piece with a total continuous surface with no openings, seams, crevices or the like below the first and second top surfaces.

### CROSS-REFERENCE TO RELATED APPLICATIONS

This application claims benefit of U.S. provisional patent application Ser. No. 60/711,708, filed Aug. 26, 2005, which is herein incorporated by reference.

### TECHNICAL FIELD

The present invention relates generally to food slicers and more particularly to a new design for a food slicer that provides for an enhanced sanitary environment, enables easier operation and cleaning and incorporates a number of enhanced ergonomic features.

### BACKGROUND

The basic design of both manual and automatic food slicers has proven to be quite effective and durable throughout the years. Although various important improvements have been made to such slicers, the overall design has not changed very much particularly with regard to the overall cleanliness, ergonomics, or ease of operation.

Today, food slicers are utilized to slice a number of food products such as meats, cheeses and the like in a variety of environments such as delicatessens, supermarkets, and restaurants to name a few. Such food slicers need to be quite durable since they tend to be used for many hours during a day by many different individuals while providing the desired performance, safety and cleanliness.

Additionally, food slicers need to be quite flexible since they need to handle a variety of products of different shapes and sizes while readily providing different thicknesses of the product being sliced. The speed at which a particular product is moved across the cutting blade also varies on automatic food slicers to improve productivity

### SUMMARY

In accordance with an embodiment, a food slicer is provided having a support member including a base portion and an upstanding portion integrally formed with the base portion. The upstanding portion includes a rotating cutting blade secured thereto for slicing food product and at least one motor positioned within the upstanding portion for rotating the cutting blade.

The base portion includes a food product table slidably secured thereto and is movable across the cutting blade for holding product while it is being sliced by the cutting blade. An adjustable gage plate also is provided for determining the thickness of a food product to be sliced by the cutting blade.

First and second top surfaces are formed by a distal end of the upstanding portion of the support member. The base portion and the upstanding portion are formed as a single piece with a total continuous surface with no openings, seams, crevices or the like below the first and second top surfaces.

### BRIEF DESCRIPTION OF THE DRAWINGS

The present disclosure will become better understood with reference to the following description and accompanying drawings, wherein:

FIG. 1 is a top right perspective view of a food slicer according to one embodiment of the present invention;

FIG. 2 is a front plan view of the food slicer of FIG. 1; and

FIG. 3 is a top perspective view of the support portion of the food slicer of FIGS. 1 and 2.

### DETAILED DESCRIPTION

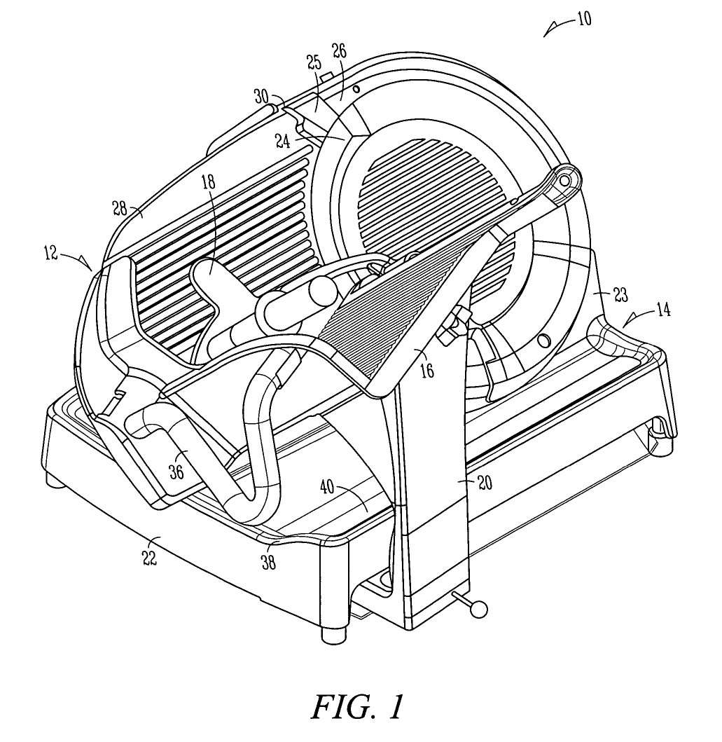

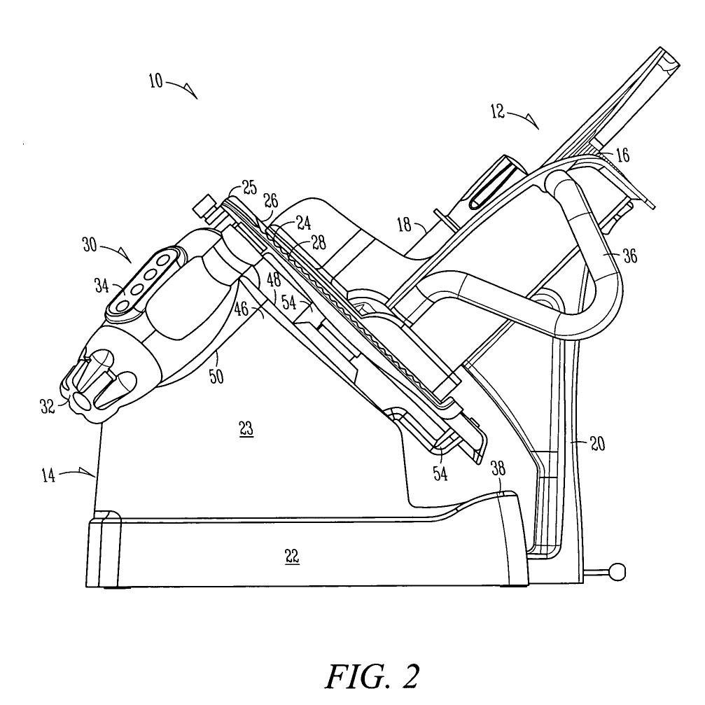

The food slicer of the present invention is generally illustrated by numeral 10 of FIGS. 1-2 wherein like parts are designated by like reference numerals. Although the present disclosure will be described with reference to the example embodiments illustrated in the figures, it should be understood that the food slicer 10 may have many alternative forms without departing from the teachings of the present invention. One of ordinary skill in the art will additionally appreciate different ways to alter the parameters of the embodiments disclosed, such as the size, shape, or type of elements or materials, in a manner that falls within the spirit and scope of the present disclosure and appended claims.

FIGS. 1 and 2 illustrate the basic components of the food slicer 10 of the present invention. The food slicer 10 substantially includes a food handling portion generally illustrated by reference numeral 12 and a support portion, housing or member generally illustrated by reference numeral 14.

The food handling portion 12 substantially includes a product table 16, a push arm or pusher 18 and a product table support arm 20. The support portion 14 substantially includes a base portion or member 22, an upstanding portion or member 23, a rotating circular slicing knife or cutting blade 24, a ring guard 25, a knife cover 26, an adjustable gage plate 28 for determining slicing thickness and a control member or operator interface 30 having a gage plate support and adjustment mechanism 32 for the gage plate 28 and control buttons 34 as illustrated in FIG. 2.

The support portion 14 also includes at least one motor (not illustrated) positioned within the inside of the upstanding portion 23. If desired, a second motor (not illustrated) may be positioned within the inside of the support portion 14 along with associated structure for automatically moving the product table 16.

Briefly, for manual slicing, a food product (not illustrated) is placed on the product table 16 beneath the pusher 18 with the end to be cut or sliced resting upon the gage plate 28 with the product table 16 in its forward position. The operator adjusts the gage plate adjustment mechanism 32 which directly moves the gage plate 28 with respect to the blade 24 to provide a slice thickness gap therebetween that corresponds to the desired thickness for slicing of the product and gets bigger with thicker slices. The control buttons 34 are then accessed to turn the motor on which in turn rotates the blade 24.

The operator then pushes the product table 16 via a handle 36 forward or to the right with respect to FIG. 1 whereby the blade 24 slices the product to the desired thickness. The operator then pulls the product table 16 backward or to the left with respect to FIG. 1 for continued slicing of the product as described above.

As FIG. 2 generally illustrates, the blade 24 essentially defines a plane of slicing of the product below which the majority of food scraps and juices tend to flow. To assist in product slicing and directing of food slices, scraps and juices below this plane of slicing, the blade 24 typically is beveled on its side facing the support portion 14.

Additionally, due to the circular shape of the blade 24, the engagement of the blade 24 and the product being sliced substantially occurs on an arc at the edge of the blade 24 closest to the gage plate 28. A small clearance gap is maintained between the blade 24 and the gage plate 28 through which sliced product moves from the top side of the gage plate 28 and blade 24 to the bottom side thereof during slicing. This arc of engagement varies depending on the size and shape of the product being sliced and moves slightly away from the gage plate 28, slightly widening the clearance gap, as the blade 24 is sharpened over time and becomes worn down. It is to be noted, however, that the gage plate 28 and the gage plate adjustment mechanism 32 are designed to be adjustable to accommodate the wearing down of the blade 24 over time so that the clearance gap therebetween remains substantially constant.

Since the support portion 14 acts as a catch area for the sliced food product, it is exposed to the vast majority of the byproducts of sliced food, including the scraps and juices mentioned above. The beveled design of the blade 24 assists in directing the majority of food product and byproducts downward toward the support portion 14 beneath the plane of slicing, away from the upstanding member 23, and in front of the arc of engagement between the blade 24 and food product as described above.

The support portion 14 is uniquely designed to reduce contamination by being free of unnecessary nooks and crannies, joints, seals, plugs, apertures or the like and other places where food scraps or juices may get caught. Additionally, the support portion 14 does not include any holes therethrough where scraps or juices could make their way underneath the food slicer 10. Thus, the support portion 14 is designed and formed to be virtually free of any seams, fasteners, control knobs, apertures, holes or the like so as to provide a smooth, continuous, seamless, unobstructed, easy to clean surface for the food product and associated byproducts. Virtually all mechanisms, motors, mounting hardware, electronics and the like are either positioned on the underside of the support portion 14, or generally above the plane of slicing and out of the way of the path of the food product and byproducts.

The gage plate adjustment mechanism 32 and controls 34 of the operator interface 30 are mounted to the upstanding portion 23 above the base portion 22 of the support portion 14 and up and out of the way of the plane of slicing and thus away from the path of the food product. By mounting the operator interface 30 in this way, the support portion 14 may further be free of control buttons, knobs or the like and provides for easy access to such controls thereby contributing to a more ergonomic design.

The support portion 14 is formed to substantially include the base portion 22 and the upstanding portion 23 and is substantially a strong and durable hollow shell. The support portion 14 preferably is integrally formed from a moldable material, such as plastic or the like. It is to be understood, however, that the particular material utilized can vary and may include stainless steel, aluminum or any other material desired and can be manufactured by any method desired.

The base portion 22 essentially acts as a catch area for the food product as it is sliced from the blade 24 where an operator can catch the food product with a hand and stack it onto the base portion 22 or onto a piece of paper or plastic placed thereon or merely let the food product fall onto the base portion 22. The base portion 22 preferably includes an outer lip 38 about its periphery substantially forming a basin to contain the food, scraps, juices or the like which fall to the base portion 22 during or after slicing.

Additionally, the base portion 22 preferably has a sloped edge portion 40 formed on the edge opposite the upstanding portion 23 and a substantially flat area 42. The sloped edge portion 40 serves to direct food, scraps, juices or the like to the flat area 42 of the base portion 22 for easy removal and cleaning.

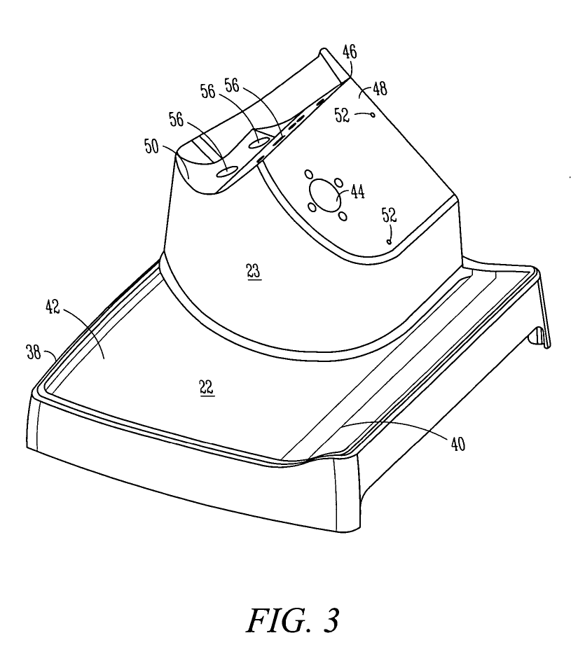

With reference to FIG. 3, the upstanding portion 23 is integrally formed with the base portion 22 and provides a mounting structure or housing for the food slicer 10. On the underside of the upstanding portion 23 and base portion 22, various components including the blade motor and other desired mechanisms may be housed.

The upstanding portion 23 includes a knife mounting aperture 44 for connection to and driving of the blade 24 and is completely sealed with appropriate gaskets or the like to prevent food scraps and juices from going therethrough. The aperture 44 is positioned toward a front edge of the upstanding member 23 so that the arc of engagement between the blade 24 and the food product falls in front of the upstanding member 23 and food scraps and the like are directed away from the aperture 44.

The upstanding member 23 also is formed with upstanding side walls that terminate at a distal end 46 having a first top surface 48 and a second top surface 50. The first top surface 48 preferably is a substantially planar surface that serves as a location to mount the ring guard 25 which supports the knife cover 26, such as at points 52 which preferably are threaded apertures that may or may not extend through the first top surface 48. The threaded apertures 52 preferably receive a standoff 54 or the like which seals the apertures 52 from byproducts as illustrated in FIG. 2. Alternatively, the standoffs 54 can be integrally formed with the first top surface 48 and include a threaded aperture at their distal ends (not illustrated) for fastening of the ring guard 25 thereto.

As FIGS. 2 and 3 illustrate, the second top surface 50 of the upstanding portion 23 substantially is formed as a recess within which the operator interface 30 is mounted and sealed with respect to the upstanding portion 23 such as with a gasket or the like (not illustrated). The second top surface 50 also may include one or more apertures 56 therein for mounting of the operator interface 30 to the upstanding member 23 and for communicating electrical and mechanical control wires, cables, or other members (not illustrated) therethrough to the operator interface 30.

It is to be noted that the base member 22 and upstanding member 23 of the support portion 14 beneath the first and second top surfaces 48 and 50 are formed as a single continuous piece with a total continuous surface with no openings, seams, crevices or the like. This “one piece body” design reduces contamination beneath the top surfaces 48 and 50 and enables easier, faster cleaning of the food slicer 10. In fact, applicant has conducted an independent study confirming the same.

It is to be noted that the operator interface 30 is positioned on the upstanding member 23 up and away from the blade 24, outside or behind the arc of engagement and out of the way of the direct path of food scraps and juices that generally fall vertically from the blade 24, while still in a location convenient for the operator. Due to the positioning of the operator interface 30 and second top surface 50 up and away from the blade 24 and first top surface 48, food scraps and juices do not tend to accumulate near the operator interface 30 and second top surface 50. Although it is not illustrated in the drawings, if desired the first top surface 48 can be designed and integrally formed to extend upward and to the left with respect to FIG. 2 to cover or shield the second top surface 50.

Numerous modifications and alternative embodiments of the present disclosure will be apparent to those skilled in the art in view of the foregoing description. Accordingly, this description is to be construed as illustrative only and is for the purpose of teaching those skilled in the art the best mode for carrying out the present disclosure. Details of the structure may vary substantially without departing from the spirit of the present disclosure, and exclusive use of all modifications that come within the scope of the appended claims is reserved. It is intended that the present disclosure be limited only to the extent required by the appended claims and the applicable rules of law.

What is claimed is:

1. A food slicer, comprising:
a support member having a base portion and an upstanding portion integrally formed with said base portion;
a rotating cutting blade secured to said upstanding portion for slicing food product;
at least one motor positioned within said upstanding portion for rotating said cutting blade;
a food product table slidably secured to said base portion and movable across said cutting blade for holding product while being sliced by said cutting blade;
an adjustable gage plate for determining the thickness of a food product to be sliced by said cutting blade; and
first and second top surfaces formed by a distal end of said upstanding portion of said support member, said base portion and said upstanding portion of said support member being formed as a single piece with a total continuous surface with no openings, seams, crevices or the like therein below said first and second top surfaces.

2. The food slicer as defined in claim 1, wherein said rotating cutting blade is positioned at an angle with respect to the vertical.

3. The food slicer as defined in claim 1, including a gage plate adjustment mechanism secured to said upstanding portion and in direct communication with an upper portion of said gage plate for adjustment of said gage plate by an operator with respect to said cutting blade to determine the thickness of a food product to be sliced.

4. The food slicer as defined in claim 1, wherein said base portion includes a continuous lip about its peripheral edges integrally formed therewith.

5. The food slicer as defined in claim 4, wherein said base portion includes a sloped surface along at least one of its peripheral edges.

6. A housing for a food slicer, comprising:
a support member having a base portion and an upstanding portion integrally formed with said base portion; and
first and second top surfaces formed by a distal end of said upstanding portion of said support member, said base portion and said upstanding portion of said support member being formed as a single piece with a total continuous surface with no openings, seams, crevices or the like therein below said first and second top surfaces.

7. The housing as defined in claim 6, wherein said housing is a casting formed from at least one of a metal, plastic, ceramic or the like.

8. The housing as defined in claim 6 wherein said housing is a molding formed from at least one of a metal, plastic, ceramic or the like.

9. A housing for a food slicer, comprising:
a support member having a base portion and an upstanding portion integrally formed with said base portion; and
upstanding side walls forming said upstanding portion, said base portion and said upstanding side walls of said upstanding portion of said support member being formed as a single piece with a total continuous surface with no openings, seams, crevices or the like therein below a distal end of said upstanding side walls.
